(19) United States
(12) Patent Application Publication
(10) Pub. No.: US 2024/0338220 A1
(43) Pub. Date: Oct. 10, 2024

(54) APPARATUS AND METHOD FOR IMPLEMENTING MANY DIFFERENT LOOP TYPES IN A MICROPROCESSOR

(71) Applicant: Simplex Micro, Inc., Austin, TX (US)

(72) Inventor: Thang Minh Tran, Austin, TX (US)

(73) Assignee: Simplex Micro, Inc., Austin, TX (US)

(21) Appl. No.: 18/603,171

(22) Filed: Mar. 12, 2024

Related U.S. Application Data
(60) Provisional application No. 63/457,325, filed on Apr. 5, 2023.

(51) Int. Cl. G06F 9/38; G06F 9/30

(52) U.S. Cl. CPC G06F 9/3806; G06F 9/30058; G06F 9/3856

(57) ABSTRACT

A processor includes a branch execution unit to detect different loop types based on the number of instructions in the loop and generates a predicted loop count to write to an entry of a branch target buffer (BTB). The different detected loop types are executed in a plurality of instruction queues in the processor depending on the loop type, which is a function of the loop size.

### RELATED APPLICATIONS

This application claims priority to U.S. provisional patent application 63/457,325, filed on Apr. 5, 2023 and entitled “Apparatus and Method for Implementing Many Different Loop Types in a Microprocessor.” This application is related to U.S. patent application Ser. No. 18/135,481, filed on Apr. 17, 2023, and entitled “Executing Phantom Loops in a Microprocessor,” which application is hereby incorporated by reference in its entirety.

### BACKGROUND

### Technical Field

The present invention relates to the field of computer processors and more particularly to execution and prediction of loops in computer processors.

### Technical Background

Loops are frequently used in many applications, i.e., artificial intelligence, machine learning, digital signal processing. In some applications, the number of iterations can be in hundreds or thousands. The loops can also be of different sizes, from a few to hundreds of instructions. The loops can be fetched many times from the instruction cache which is a major factor in power consumption.

Thus, there is a need for a microprocessor which efficiently predicts different loop types, consumes less power, has a simpler design, and is scalable with consistently high performance.

### SUMMARY

In a microprocessor, a branch prediction unit predicts future instructions with high accuracy. In one embodiment, a basic block branch prediction is used for branch prediction where a basic block is defined as a straight-line code sequence with no branches in except to the entry, and no branches out except at the exit. The instruction address at the entry point is used to look up the branch prediction and the BTB contains information for the instruction address at exit point and the instruction address for the target instruction. A loop is a basic block or multiple basic blocks that is repeated many times. An instruction fetch unit includes an instruction tag queue and an instruction cache queue to keep the fetched instructions before sending them to the instruction decode unit. The instruction decode unit includes an instruction decode queue to hold instructions before sending them to the instruction issue unit. The loops are implemented in the instruction tag queue, instruction cache queue and instruction decode queue.

In a disclosed embodiment, the branch target buffer includes different predicted branch instruction types wherein the branch instruction types can be expanded to include different loop types. The loop types are based on the number of instructions in a loop. In an embodiment, the loop types can be classified as tiny, small, large, and extra-large loops. In another embodiment, the implementation of loops in different queues can be combined to form nested loops. A tiny loop can fit into an instruction decode queue of the decode unit, a small loop can fit into an instruction cache queue of the instruction fetch unit, a large loop can fit into an instruction tag queue of the instruction fetch unit, and an extra-large loop is in the branch prediction queue which has more instructions than the instruction tag queue size. Different methods are used to handle different the loop types.

### BRIEF DESCRIPTION OF THE DRAWINGS

Aspects of the present invention are best understood from the following description when read with the accompanying figures.

FIG. 1 is a block diagram illustrating a processor based data processing system in accordance with present invention;

FIG. 2 is a block diagram illustrating a basic block concept for branch prediction;

FIG. 3 is a block diagram illustrating fetching and predicting instructions in the branch prediction unit and various queues in the instruction fetch unit and the instruction decode unit;

FIG. 4 is a block diagram illustrating an exemplary of various queue sizes and types;

FIG. 5 is a block diagram illustrating an example of unrolling of loop instructions in a virtual instruction decode queue;

FIG. 6 is a block diagram illustrating two basic blocks forming nested loops of inner and outer loops;

FIG. 7A and FIG. 7B illustrate encoding of branch types and nested loop types for an entry in the branch target buffer; and

FIG. 8 is a block diagram illustrating nested loop encoding in an entry of a branch target buffer for an inner loop of a tiny loop type and an outer loop of a small loop type.

### DETAILED DESCRIPTION

The following description provides different embodiments for implementing aspects of the present invention. Specific examples of components and arrangements are described below to simplify the explanation. These are merely examples and are not intended to be limiting. For example, the description of a first component coupled to a second component includes embodiments in which the two components are directly connected, as well as embodiments in which an additional component is disposed between the first and second components. In addition, the present disclosure repeats reference numerals in various examples. This repetition is for the purpose of clarity and does not in itself require an identical relationship between the embodiments.

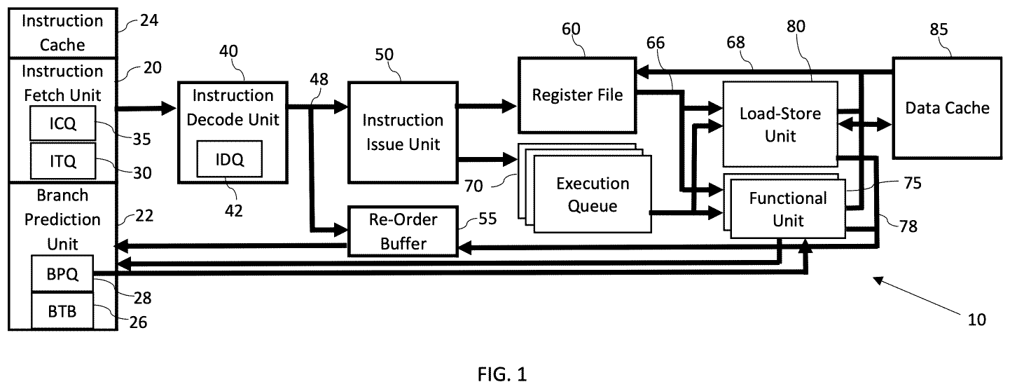

FIG. 1 is a block diagram of a microprocessor based data processing system. The exemplary system includes a microprocessor 10 having an instruction fetch unit 20, a branch prediction unit 22, an instruction cache 24, an instruction decode unit 40, an instruction issue unit 50, a re-order buffer 55, a register file 60, a plurality of execution queues 70, a plurality of functional units 75, a load-store unit 80, and a data cache 85. The microprocessor 10 includes a plurality of read buses 66 to transport data from registers in the register file 60 to the functional units 75 and the load-store unit 80. The system also includes a plurality of write buses 68 to transport result data from the functional unit 75, the load-store unit 80, and the data cache 85 to the register file 60. The functional unit 75 and the load-store unit 80 also notify the re-order buffer 55 of completion of instructions. The instruction decode unit 45 sends a plurality of instructions through bus 48 to the instruction issue unit 50 and the re-order buffer 55. The re-order buffer 55 keeps track of the order of instructions as they are executed out-of-order in the execution pipeline from instruction issue unit 55 to the data cache 85. The completed instructions in the re-order buffer 55 are retired in-order. Branch execution unit, one of the functional units 75, is coupled to the re-order buffer 55 and the branch prediction unit 22 for branch misprediction to flush all subsequent instructions and to fetch instruction from new instruction address.

In the microprocessor system 10 the instruction fetch unit 20 fetches the next instruction(s) from the instruction cache 24 to send to the instruction decode unit 40. One or more instructions can be fetched per clock cycle from the instruction fetch unit 20 depending on the configuration of microprocessor 10. For higher performance, in certain embodiments, microprocessor 10 fetches more instructions per clock cycle for the instruction decode unit 40. The instruction addresses are referred to as program counters (PC) of the instructions. If the instructions are not in the instruction cache 24 (commonly referred to as an instruction cache miss), then the instruction fetch unit 20 sends a request to external memory (not shown) to fetch the required instructions. The external memory may consist of hierarchical memory subsystems, for example, one or more of an L2 cache, an L3 cache, read-only memory (ROM), dynamic random-access memory (DRAM), flash memory, and disk drives. The external memory is accessible by both the instruction cache 24 and the data cache 85. The instruction cache 24 comprises a plurality of cache lines wherein the cache line size comprises a plurality of data bytes. For example, the instruction cache 24 size may be 32K bytes which consists of 1024 cache lines of 32 bytes per cache line. The address of an instruction cache line is referred to as the instruction tag address. An instruction typically consists of 4 bytes in which the cache line has 8 instructions.

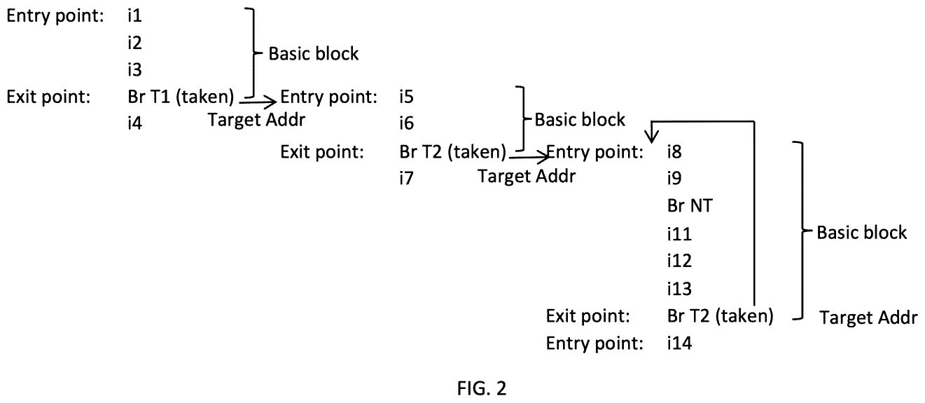

In one embodiment, the branch prediction unit 22 is implemented in accordance with a basic-block algorithm. A basic block is defined as a straight-line code sequence with no branches in except to the entry, and no branches out except at the exit. An example is shown in FIG. 2. In the example of FIG. 2, the first basic block has 4 instructions, the second basic block has 3 instructions, and the third basic block has 7 instructions. Note that the last basic block with instruction i8 to Br T2 includes Br NT which is a not-taken branch. If the Br NT remains non-taken throughout the program execution, then the last basic block remains the same. The modified definition for the basic block is defined to include a branch as long as the branch is non-taken. This modification is useful on later discussion of nested loop. The branch target address of the third basic block is the entry point of same basic block, which is an indication of a loop. With basic-block branch prediction, a loop can be detected and marked as such in the branch target buffer. The branch prediction is based on the entry point of the basic block to the exit point, or the instruction address of the taken branch instruction. The instruction address of the exit point is included in the branch target buffer 26 to locate the exit point or the branch instruction of the basic block. The entry point address is used to look up in a branch target buffer 26 of the branch prediction unit 22 to predict the target address of the branch instruction at the exit point of the basic block. The target address of the predicted taken branch is the entry point of the next basic block to predict the next target address. In case, a branch is predicted and not taken then the instruction address after the exit point is the entry point of the next basic block as illustrated by instructions i4, i7, and i14. For example, the loop of the illustrated third basic block can be predicted to be non-taken based on the previous execution of the loop. The instruction address of instruction i14 is the entry point of the next basic block. The instruction address of both the exit point (next) and the target address are included in the branch target buffer 26 to be used as the instruction address of the entry point of the next basic block due to branch prediction of taken or non-taken.

A branch execution unit (one of the functional units 75) detects a loop and loop type based on 3 factors. The first factor in loop detection is when the taken target address is the same as the entry-point address. The second factor is loop iteration count by counting up to a loop count or counting down to zero from a loop count. The counting up is based on a less-than-or-equal branch instruction while the counting down is based on a greater-than-or-equal branch instruction. The third factor is the number of instructions in a loop which is used to determine the loop type. In one embodiment, the loop types are classified as one of four types: tiny, small, large, and extra-large. A tiny loop is a loop that has a number of instructions that can fit into an instruction queue in the decode unit, a small loop is a loop that has a number of instructions that can fit into an instruction cache queue, a large loop is a loop that has a number of instructions that can fit into an instruction tag queue (more than 1 cache lines), and an extra-large loop is a loop that has a number of instructions that has more instructions than the instruction tag queue.

Assuming the instructions are all of the same size, i.e. 4-byte instructions, then the entry-point and exit-point addresses can be used to calculate the number of instructions in a loop. If the instructions are of different sizes, i.e. 4-byte and 2-byte instructions, then the instruction issue unit 50 keeps track of instruction count when the entry-point address is encountered and sends the instruction count with the branch instruction to the branch execution unit 75. In one embodiment, the instruction queue contains a plurality of instructions, and the number of instructions is determined based on the starting address and ending address of the basic block. For example, a basic block in which the starting address is 0x0000_0000 and ending address is 0x0000_0030 has 48 bytes or 12 4-byte instructions. The number of instructions in a basic block is referred as the block length or loop length if the basic block is a loop.

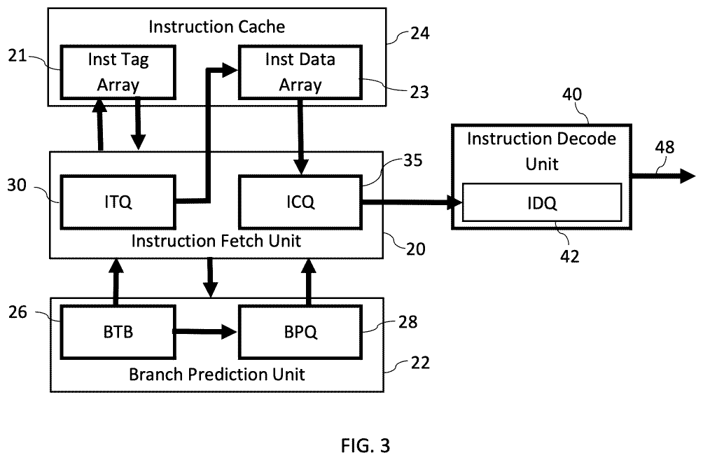

Turning now to FIG. 3 which illustrates the front-end of the microprocessor to predict and fetch instructions to the instruction issue unit 50. The instruction fetch unit 20 includes an instruction tag queue (ITQ) 30 which consists of plurality of instruction tag address to access the tag array 21 of the instruction cache 24 for hit/miss information and an instruction cache queue (ICQ) 35 to hold the cache line data from the data array 23 of the instruction cache 24. The ITQ 30 comprises a plurality of cache line addresses for the cache lines in the instruction data array 23. The ICQ 35 comprises of a single or multiple cache lines, as an example, the ICQ 35 can hold 2 cache lines or 16 instructions. Pluralities of instructions are sent from the ICQ 35 to the instruction decode queue (IDQ) 42 of the instruction decode unit 40 where the instructions are decoded and sent to the instruction issue unit 50 and the re-order buffer 55 through the bus 48.

The instruction fetch unit 20 is also coupled to the branch prediction unit (BPU) 22 which predicts the next instruction address when a branch is detected by the branch prediction unit 22. The branch prediction unit 22 includes a branch target buffer (BTB) 26 that stores a plurality of entry-point addresses, branch types including loops, loop counts, exit-point addresses, and target addresses of stored basic blocks. The instructions are predicted and fetched ahead of the pipeline execution. The branch prediction unit 22 includes a branch prediction queue (BPQ) 28 to track many predicted basic blocks as they progress through many pipeline stages of the microprocessor 10. In one embodiment, the PC is calculated at 3 different stages: in BPQ 28, in instruction issue unit 50, and in a retire stage of the re-order buffer 55 of the microprocessor 10. The BPQ 28 also tracks the predicted loop to ensure termination of the loop for proper calculation of PC in the instruction issue unit 50 and in the retire stage of the microprocessor 10.

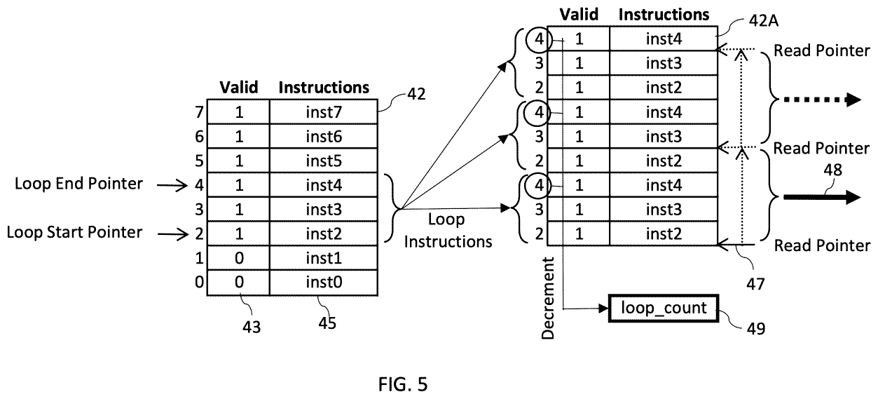

The BPQ 28, the ITQ 30, the ICQ 35, and the IDQ 42 are each designated as circular buffer with read and write pointers rotating from the tail entry to the head entry of the queue. The loop buffer is also a circular buffer within the queue with its own loop start pointer and loop end pointer where the loop end pointer wraps around to the loop start pointer. Numerous iterations of the loop are issued to the next pipeline stage will be shown later in example of FIG. 5. The number of instructions in IDQ 42 is capable of storing corresponds to a tiny loop. The number of instructions in ICQ 35 is capable of storing corresponds to a small loop. In one embodiment, the ICQ 35 comprises of 1 or a plurality of cache lines from the instruction data array 23 of the instruction cache 24. The number of instructions in ITQ 30 is capable of storing corresponds to a large loop. The large loop type has a plurality of cache lines. The ITQ 30 dispatches requests to the instruction data array 23 to read cache lines to the ICQ 35. Finally, if the loop size is larger than the ITQ size, then the extra-large loop is stored in the BPQ 28 where plurality of iterations of the extra-large loop is sent 1 cache line at a time to the instruction fetch unit 20. The illustrated embodiment of FIG. 3 shows that the instruction tag array 21 is accessed before the instruction data array 23 is accessed. Four loops of different sizes can be detected by the branch execution unit 75 and implemented in 4 different queues, BPQ 28, ITQ 30, ICQ 35, and IDQ 42 but the branch execution unit 75 can be configured to detect any number of loop types and not necessary all 4 different size loops. In another embodiment, only 2 loop types, tiny and small, are implemented in IDQ 42 and ICQ 35. Yet, in another embodiment, only small loop is implemented in ICQ 35.

The loop and loop count are detected and classified into different loop types by the branch execution unit 75 and stored in the BTB 26. From the point of view of the BTB 26, the loop is non-taken where the branch prediction unit 22 and the instruction fetch unit 20 continues to fetch sequential instructions after the loop. In the example of FIG. 2, the next instruction address after the exit-point address of the loop is the next entry-point address of the sequential basic block. The loop is a basic block which is always predicted as non-taken by the BTB 26.

In FIG. 3, the loop is predicted by the BTB 26, and the predicted instruction address is sent to the instruction fetch unit 20 and the BPQ 28. Depending on the loop type, the loop is sent to one of the queues such as the IDQ 42, the ICQ 35, the ITQ 30, or the BPQ 28. The BPQ 28 keeps track of all predicted basic blocks by storing the entry and exit point addresses as the basic blocks progress through the pipeline stages of the microprocessor 10. The loop count for a loop is also tracked in the BPQ 28. From the point of view of the branch execution unit 75 each iteration of the loop is predicted as taken until the last iteration of the loop. The BPQ 28 is coupled to the branch execution unit 75 to provide the correct prediction information. The predicted loop count is sent with the predicted loop to the queues so that the correct number of loop iterations is sent to the execution pipeline.

Referring back to FIG. 1 the instruction decode unit 40 decodes instructions for instruction type and register operands. The register operands, as an example, may consist of 2 source operands and 1 destination operand. The operands are referenced to registers in the register file 60. The decoded instructions are sent to instruction issue unit 50 to dispatch instructions to the execution queues 70 where the instructions wait until data dependencies and resource conflicts are resolved before being issued to the functional unit 75 or the load-store unit 80. The load-store unit 80 accesses the data cache 85 to read data for a load instruction and to write store data for a store instruction. The data for load and store instructions may not be in the data cache 85 (commonly referred to as data cache miss), and if this is the case then the load-store unit 80 sends a request to external memory (not shown) to fetch the required data. The result data from the data cache 85, the load-store unit 80, and the functional units 75 are written back to the register file 60 through the write buses 68. The source operand data are read from the register file 60 to the functional units 70 and the load-store unit 80 on a read bus 66.

The integrated circuitry employed to implement the units shown in the block diagram of FIG. 1 may be expressed in various forms including as a netlist which takes the form of a listing of the electronic components in a circuit and the list of nodes that each component is connected to. Such a netlist may be provided via an article of manufacture as described below.

In other embodiments, the units shown in the block diagrams of the various figures can be implemented as software representations, for example in a hardware description language (such as for example Verilog) that describes the functions performed by the units described herein at a Register Transfer Level (RTL) type description. The software representations can be implemented employing computer-executable instructions, such as those included in program modules and/or code segments, being executed in a computing system on a target real or virtual processor. Generally, program modules and code segments include routines, programs, libraries, objects, classes, components, data structures, etc. that perform particular tasks or implement particular abstract data types. The program modules and/or code segments may be obtained from another computer system, such as via the Internet, by downloading the program modules from the other computer system for execution on one or more different computer systems. The functionality of the program modules and/or code segments may be combined or split between program modules/segments as desired in various embodiments. Computer-executable instructions for program modules and/or code segments may be executed within a local or distributed computing system. The computer-executable instructions, which may include data, instructions, and configuration parameters, may be provided via an article of manufacture including a non-transitory computer readable medium, which provides content that represents instructions that can be executed. A computer readable medium may also include a storage or database from which content can be downloaded. A computer readable medium may also include a device or product having content stored thereon at a time of sale or delivery. Thus, delivering a device with stored content, or offering content for download over a communication medium may be understood as providing an article of manufacture with such content described herein.

The aforementioned implementations of software executed on a general-purpose, or special purpose, computing system may take the form of a computer-implemented method for implementing a microprocessor, and also as a computer program product for implementing a microprocessor, where the computer program product is stored on a non-transitory computer readable storage medium and includes instructions for causing the computer system to execute a method. The aforementioned program modules and/or code segments may be executed on suitable computing system to perform the functions disclosed herein. Such a computing system will typically include one or more processing units, memory and non-transitory storage to execute computer-executable instructions.

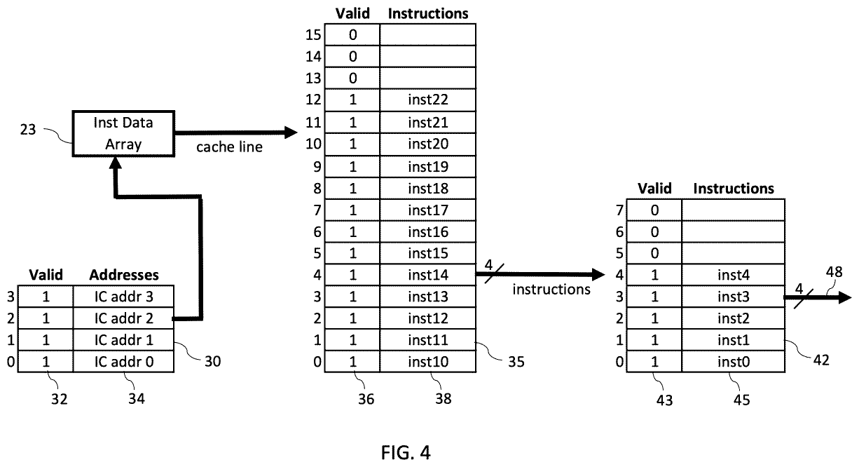

FIG. 4 illustrates an embodiment of the queue structures for the IDQ 42, the ICQ 35, and the ITQ 30. Each queue comprises 2 fields, valid and data. The ITQ 30 has 4 entries each with valid field 32 and instruction cache line address field 34. The ICQ 35 has 16 entries each with valid field 36 and instruction field 38. The IDQ 42 has 8 entries each with valid field 42 and instruction field 45. The queues may include more fields (not shown) to keep predecode information, branch and loop information. In this example, the instruction cache line has 32 bytes, and the ICQ 35 can store up to 2 cache lines. The ITQ 30 sends a request to the instruction data array 23 to read a cache line and write to the ICQ 35 as long as the ICQ 35 has enough available entries for the cache line. If the ICQ 35 does not have enough entries available to permit writing of the entire cache line into the ICQ 35 then a partial cache line is written into the ICQ 35 and a stall is performed until sufficient entries become available to permit writing of the entire cache line. The ICQ 35 sends 4 instructions to the IDQ 42, and the IDQ 42 sends 4 instructions through bus 48 to the instruction issue unit 50 and the re-order buffer 55. The instructions from the ICQ 35 are written to the IDQ 42 as long as the IDQ 42 has enough available entries. The ICQ 35 can send fewer than 4 instructions to the IDQ 42. In each queue, the loop is part of the queue, the tiny loop has 8 or fewer instructions, the small loop has 16 or fewer instructions, and the large loop has 4 or fewer cache lines with 32 maximum instructions. FIG. 4 is for illustration purpose, the number of entries in the queues can be larger or smaller, the cache line can have more or fewer number of bytes, and the number of instructions sent from the ICQ 35 and IDQ 42 can be more or fewer than 4 instructions.

FIG. 5 shows an example implementation of a loop in the IDQ 42. As shown, inst2 to inst7 are valid and the loop has 3 valid instructions, inst2 to inst4. In one embodiment, for simplicity, the instructions before the loop and after the loop are issued independent of the loop instructions. Meaning that inst0 and inst1 are issued to the instruction issue unit 50 in 1 cycle and loop instructions, inst2 to inst4, are issued to the instruction issue unit 50 in the next cycle. The loop start pointer and loop end pointer are used to identify the first and last instructions of the loop. The iterations of loop instructions are virtually unrolled by many iterations so that instructions can be dispatched seamlessly across the loop iteration as shown in virtual view of IDQ 42A. The read pointer 47 is incremented by the number of instructions dispatched on bus 48 as shown in 2 consecutive cycles by incrementing the read pointer 47 twice. Each time the instruction associated with the loop end pointer, inst4, is dispatched on bus 48, the loop count 49 is decremented. The loop count 49 can be decremented more than 1 in a single cycle if inst4 is dispatched multiple times. When the loop count 49 is zero, then the loop is complete, and the read pointer is converted back to the read pointer for the IDQ 42. For example, if the loop count is zero after the first iteration, then the read pointer will be 3 and if the loop count is zero after the second iteration, then the loop count is 4 as shown in the dashed read pointers for virtual IDQ 42A. The virtual unrolling described above results in instructions in a loop being automatically provided for the multiple iterations of the loop to the next stage in the processor pipeline, which comprises the instruction issue unit 50 and the re-order buffer 55. In operation, for a loop with 32 iterations, if it is unrolled twice then the instructions of the loop are duplicated such that the loop will have 16 iterations. Unrolling the loop four times results in duplicating the instructions of the loop four times such that the loop will have eight iterations. A full unrolling of the loop will result in the loop being duplicated 32 times such that there are no iterations of the loop. In the virtual unrolling referred to above the loop may be fully unrolled and four instructions (in this example) are read at a time to send to the next stage. The word virtual in the virtual unroll operation means that the issue logic sees only four instructions at a time in the full unrolling of the loop. From the instruction decode point of view, it looks like the loop is fully unrolled in the IDQ 42A.

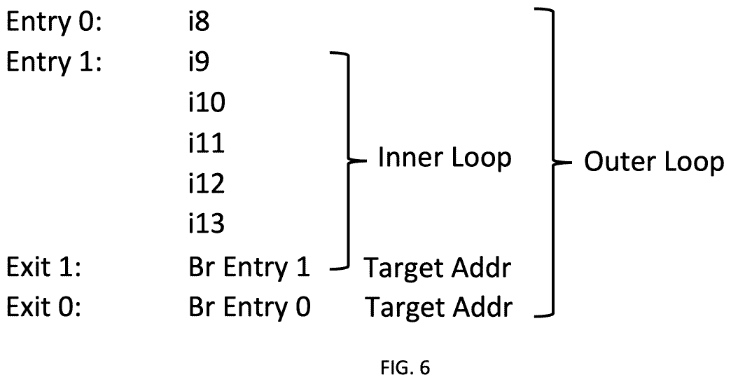

The loop prediction can expand to include nested loop prediction. FIG. 6 shows a nested loop where the inner loop is a basic block with entry point Entry 1 and exit point Exit 1 and the outer loop is a basic block with entry point Entry 0 and exit point with Exit 0. The predicted loop is defined as always non-taken from the BTB 26 point of view. In the modified definition of the basic block, the inner loop is always non-taken, thus the outer loop is a basic block. The branch execution unit 75 detects the outer loop prediction when the target address of the Br Entry 0 is the same as the Entry 0. The Entry 0 must be at or before Entry 1 in order for the outer loop to be predicted. In the example of FIG. 6, the Entry 0 and Entry 1 can be the same.

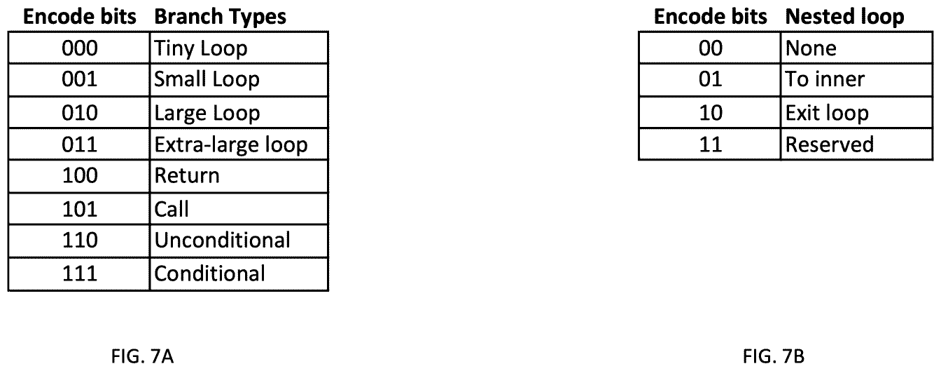

FIG. 7A shows a sample encoding for branch types which is stored with every predicted basic block prediction in the BTB 26. The normal branch types are return, call, unconditional, and conditional branches. In one embodiment, the return, call, and unconditional branches are always taken while the conditional branch can be taken or not-taken depending on a prediction algorithm. The predicted loops are encoded as shown in the top 4 rows of the branch types. Note that the most significant bit of the loop prediction is “0” indicating that the loop basic block is not taken. The BTB 26 fetches the sequential basic block by using the exit point address of the basic block.

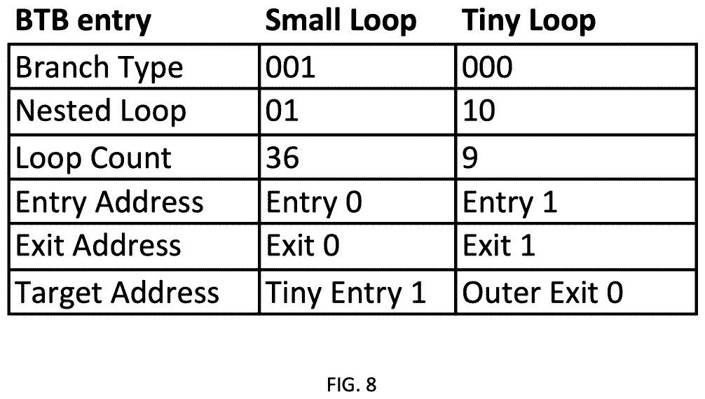

FIG. 7B shows a sample encoding for entering and existing the inner loop of the nested loop. The queues in FIG. 4 make implementation of the nested loops straight forward. For example, a predicted inner loop may be a tiny loop in IDQ 42 while a predicted outer loop may be a small loop in ICQ 35 or a large loop in ITQ 30. The loops in the queues are independently dispatched instruction to the next queue or next stage (as for IDQ 42). In the foregoing example, the tiny loop in IDQ 42 remains for a number of cycles to dispatch instructions on bus 48, which will cause IDQ 42 to become full and stall instructions from the outer loop in ICQ 35. In one embodiment, each queue can handle only 1 loop, thus the outer loop must be in the next queue level regardless of the loop size. For example, it the inner loop is a tiny loop with 3 instructions and the outer loop has 5 instructions, then the outer loop is set with small loop type to use the ICQ 35 for dispatching loop instructions. The nested loop encoding is from the point of view of the BTB 26. In the example of FIG. 6, the BTB 26 encounters the Entry 0 first where the encoding indicates the next basic block is an inner loop and exiting of inner loop is to the sequential address of the outer loop. Further explanation of the nested loops is shown in FIG. 8.

FIG. 8 shows contents of a BTB 26 entry which includes branch type, nested loop, loop count, entry-point address, exit-point address, and target address. The second column is an example of the outer loop which is the small loop type, and the third column is an example of the inner loop which is a tiny loop type. The predicted loop does not use the target address field of the BTB entry because the predicted loop is always non-taken. The nested loops take advantage of the target address field to store the next basic block address. The outer loop (second column) is the small loop type where the nested loop bits “01” indicate use of the target address field to access the inner loop. The inner loop (third column) is the tiny loop type where the nested loop bits “10” indicates using of the target address field for sequential address of the outer loop to exit the nested loops.

The foregoing explanation described features of several embodiments so that those skilled in the art may better understand the scope of the invention. Those skilled in the art will appreciate that they may readily use the present disclosure as a basis for designing or modifying other processes and structures for carrying out the same purposes and/or achieving the same advantages of the embodiments herein. Such equivalent constructions do not depart from the spirit and scope of the present disclosure. Numerous changes, substitutions and alterations may be made without departing from the spirit and scope of the present invention.

Although illustrative embodiments of the invention have been described in detail with reference to the accompanying drawings, it is to be understood that the invention is not limited to those precise embodiments, and that various changes and modifications can be affected therein by one skilled in the art without departing from the scope of the invention as defined by the appended claims.

What is claimed is:

1. A processor comprising:
a branch target buffer (BTB) that stores a predicted loop type of a loop, the BTB including a plurality of BTB entries addressable by an entry address, each of the BTB entries including a branch type comprising a loop type and a loop count, wherein the loop type is one of a plurality of loop types that are classified as a function of number of instructions;
a first instruction queue that processes a plurality of iterations of the loop in response to the loop being classified as a first loop type; and
a second instruction queue that processes a plurality of iterations of the loop in response to the loop being classified as a second loop type.

2. The processor of claim 1 wherein the first loop type is classified as a function of a number of instructions that fit into the first instruction queue.

3. The processor of claim 1 wherein the second instruction queue comprises:
a plurality of instruction cache line addresses and wherein the second loop type is classified as function of a number of cache lines required for loop instructions; and
wherein the number of cache lines fit into the second instruction queue.

4. The processor of claim 1 further comprising:
an instruction issue unit that dispatches instructions to one or more execution queues;
a branch execution unit that detects the loop and generates for the loop, the predicted loop type and stores for the loop, the branch type, loop type and loop count with the entry address for the loop to the BTB, the branch execution unit comprising a branch prediction queue that,
tracks branch predictions including predicting loops; and
tracks a predicted loop count in the branch execution unit and the instruction issue unit for instruction address calculation.

5. The processor of claim 1 wherein instructions of the loop form a basic block.

6. The processor of claim 2 wherein the first instruction queue and the second instruction queue each operate to virtually unroll instructions in the corresponding plurality of iterations to a next pipeline stage of the processor.

7. The processor of claim 6 wherein one or more of the first instruction queue and the second instruction queue process sequential instructions after the loop concurrently during execution of the loop.

8. The processor of claim 1 wherein the loop type of the loop corresponds to a nested loop and wherein the first instruction queue processes iterations of an inner loop of the loop and wherein the second instruction queue processes iterations of an outer loop of the loop.

9. The processor of claim 8 wherein each entry of the BTB includes:
encoded bits that identify entry into the inner loop and exiting from the inner loop of the nested loop; and
a branch target address field that identifies an entry address for the inner loop.

10. The processor of claim 1 wherein a branch execution unit detects a loop type based on the number of instructions in the loop and the loop count to write to an entry in the BTB.

11. A processor comprising:
a branch execution unit that identifies a loop and classifies the loop in accordance with a number of instructions in the loop into one of a plurality of loop types;
a branch target buffer (BTB), including a plurality of BTB entries addressable by an entry address, the BTB receiving from the branch execution unit, an entry address for the loop, a loop type for the loop, and a predicted loop count for the loop;
a branch prediction queue that tracks all branch predictions and tracks the predicted loop count in the branch execution unit and the instruction issue unit for program counter calculation;
an instruction queue that processes a plurality of iterations of the loop based on a first loop type and wherein the first loop type is based on the number of instructions that fit into the instruction queue and wherein the loop instructions are virtually unrolled and wherein the loop instructions from the plurality of loop iterations can be read and sent to a next pipeline stage of the processor; and
an instruction address queue that processes the plurality of iterations of the loop based on a second loop type and wherein the instruction address queue comprises one or more instruction cache line addresses and wherein the second loop type is based on a number of cache lines required for loop instructions and wherein the number of cache lines fit into the instruction address queue and wherein the instruction cache line addresses in the loop are part of the instruction address queue and wherein the cache line addresses in the loop are virtually unrolled and wherein the cache line addresses from the plurality of loop iterations can be read and sent to the next pipeline stage of the processor.

12. A computer program product stored on a non-transitory computer readable storage medium and including computer system instructions for causing a computer system to execute a method that is executable by a processor, the method detecting a loop type in a series of instructions and generating a predicted loop count, the method comprising:
identifying in the series of instructions, a basic block of instructions and classifying the basic block of instructions as a loop;
classifying the loop into one of a plurality of loop types based on a number of instructions in the loop;
sending the basic block of instructions to a first instruction queue if the loop type comprises a first loop type; and
sending the basic block of instructions to a second instruction queue if the loop type comprises a second loop type.

13. The computer program product of claim 12 wherein the method further comprises:
generating the predicted loop count for the loop; and
generating a program counter calculation as a function of the predicted loop count.

14. The computer program product of claim 12 wherein the method further comprises:
if the loop comprises the first loop type, virtually unrolling the basic block of instructions in the first instruction queue; and
sending instructions of the basic block of instructions from a plurality of iterations of the loop to a next pipeline stage.

15. The computer program product of claim 14 wherein the method further comprises:
writing sequential instructions after the loop into the first instruction queue.

16. The computer program product of claim 12 wherein the basic block of instructions comprises an inner loop, wherein the method further comprises:
predicting the inner loop;
classifying the inner loop as the first loop type; and
classifying an outer loop of the loop as the second loop type.

17. The computer program product of claim 16 wherein the method further comprises:
writing prediction bits associated with the inner loop to an entry of a branch target buffer (BTB) to cause the BTB to use a target address field of the BTB to access a basic block in the BTB that comprises the inner loop and access another basic block in the BTB to exit the inner loop.
